(19) United States
(12) Patent Application Publication
(10) Pub. No.: US 2025/0132393 A1
(43) Pub. Date: Apr. 24, 2025

(54) SCALABLE MANUFACTURING PROCESS FOR BATTERY CELLS WITH STACKED ELECTRODES

(71) Applicant: GM GLOBAL TECHNOLOGY OPERATIONS LLC, Detroit, MI (US)

(72) Inventors: Binsong Li, Troy, MI (US); Liang Xi, Northville, MI (US); SriLakshmi Katar, Troy, MI (US)

(73) Assignee: GM GLOBAL TECHNOLOGY OPERATIONS LLC, Detroit, MI (US)

(21) Appl. No.: 18/490,412

(22) Filed: Oct. 19, 2023

(51) Int. Cl. H01M 10/058; H01M 10/04; H01M 10/0525

(52) U.S. Cl. CPC H01M 10/058; H01M 10/0422; H01M 10/049; H01M 10/0525

(57) ABSTRACT

A method of manufacturing a battery cell includes providing a battery cell container. The method also includes generating a first battery monocell having a respective anode, cathode, first separator arranged therebetween, and a second separator arranged adjacent to the corresponding anode. The method additionally includes generating a second battery monocell having a respective anode, cathode, first separator arranged therebetween, and a second separator arranged adjacent to the corresponding anode. The method also includes stacking the first battery monocell and the second battery monocell such that the second separator of the first battery monocell is adjacent to the cathode of the second battery monocell. The method further includes arranging the stacked first and second battery monocells in the battery cell container.

### INTRODUCTION

The present disclosure relates to a scalable manufacturing process for battery cells with stacked electrodes.

Electro-chemical battery cells may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental and ease-of-use benefits compared to disposable batteries. Electro-chemical batteries may be used to power such diverse items as toys, consumer electronics, and motor vehicles.

An electro-chemical battery includes at least one anode and cathode pair sealed in a cell container. The anode and cathode electrodes are typically configured as wires or plates. The electrodes of an electro-chemical battery are typically immersed in a liquid electrolyte or separated by a solid electrolyte film that conducts ions as the battery charges or discharges. Battery cells may include one or more stacks of subject electrodes to accommodate specific power, energy, and packaging requirements. Respective anode and cathode electrodes in such stacks are generally connected by corresponding weld tabs, themselves connected to battery terminals mounted externally to the cell container.

Battery cells come in various sizes and shapes—cylindrical, prismatic, and pouch cells are widely used. Multi-cell rechargeable energy storage systems (RESSs) frequently employ many battery cells arranged in arrays, typically on the order of several hundred to several thousand cells for an electric vehicle. For example, a plurality of cells may be connected in parallel to form a single layer, a plurality of layers may be connected in series to form a battery module, and a number of such modules may be assembled in series to form a battery pack having desired output. Each battery cell in such an array may include multiple stacks of electrodes. Accordingly, an efficient process for manufacturing electrodes and electrode stacks at scale for such battery cell arrays may be desired.

### SUMMARY

A method of manufacturing a battery cell includes providing a battery cell container. The method also includes generating a first battery monocell having a respective anode, cathode, first separator arranged therebetween, and a second separator arranged adjacent to the corresponding anode. The method additionally includes generating a second battery monocell having a respective anode, cathode, first separator arranged therebetween, and a second separator arranged adjacent to the corresponding anode. The method also includes stacking the first battery monocell and the second battery monocell such that the second separator of the first battery monocell is adjacent to the cathode of the second battery monocell. The method further includes arranging the stacked first and second battery monocells in the battery cell container.

Stacking the first battery monocell and the second battery monocell may include arranging one or more spring elements between the first and second battery monocells.

Stacking the first battery monocell and the second battery monocell may additionally include arranging a first support element in contact with the cathode of the first battery monocell and a second support element in contact with the second separator of the first battery monocell. The spring element(s) may thereby be sandwiched by the first and second support elements.

Alternatively, stacking the first battery monocell and the second battery monocell may include arranging a foam element between the first and second battery monocells.

Generating the first and second battery monocells may include extracting the respective anodes and cathodes from corresponding electrode material sheets.

Extracting the respective anodes and cathodes may include either die or laser cutting the respective anodes and cathodes from corresponding electrode material sheets.

The electrode material sheets may be constructed from respective anode and cathode material. In such an embodiment, generating the first and second battery monocells may include coating the respective electrode material onto a corresponding base material foil.

Each of the respective anodes and cathodes may include at least one conductive tab. In such an embodiment, coating the respective electrode material onto a corresponding base material foil may include generating a respective coated material strip for each of the anodes and the cathodes. and at least one exposed material section on each respective base material foil for the corresponding conductive tabs. Additionally, coating the respective electrode material on the base material foil may include generating at least one exposed material section on each respective base material foil for the corresponding conductive tabs.

Each cathode of the respective first and second battery monocells may be defined by a corresponding outer perimeter. In such an embodiment, generating the first and second battery monocells includes arranging each cathode in a column and coating the outer perimeter of each respective cathode with an electrically insulating material.

Generating the first and second battery monocells may include masking each conductive tab prior to coating the outer perimeter of each respective cathode.

The battery cell container may include battery terminals. Also, the first and second battery monocells may be stacked along a stack axis. In such an embodiment, the method may additionally include mechanically connecting the conductive tabs of each battery monocell to the battery terminals via weld tabs arranged along the stack axis. The subject weld tabs may include expandable portions configured to absorb alternating expansion and contraction of the first and second battery monocells when the battery cell is respectively charging and discharging.

The battery cell may be a cylindrical, prismatic, or pouch cell with either liquid or solid-state electrolyte.

Furthermore, the battery cell may be a lithium-ion cell.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of three exemplary embodiments of a battery cell, each having a corresponding cell container.

FIG. 2 is a schematic inside view of the cylindrical battery cell shown in FIG. 1, illustrating multiple electrode stacks arranged inside the respective cell container and electrically conductive tabs with expandable portions arranged between the electrode stacks, according to the disclosure.

FIG. 3 is a schematic close-up partial sectional view of the cylindrical battery cell and the electrode stacks shown in FIG. 2, illustrating an arrangement of anodes and cathodes therein, according to the disclosure.

FIG. 4 is a schematic close-up top view of a pair of anodes and cathodes shown in FIG. 3, according to the disclosure.

FIG. 5 is a schematic inside view of the prismatic battery cell shown in FIG. 1, illustrating multiple electrode stacks arranged inside the respective cell container and having electrically conductive tabs with expandable portions arranged between the electrode stacks, according to the disclosure.

FIG. 6A is a schematic perspective view of an embodiment of the prismatic battery cell shown in FIG. 1, illustrating multiple vertically arranged electrode stacks arranged inside the respective cell container and electrically conductive tabs with expandable portions arranged between the electrode stacks, according to the disclosure.

FIG. 6B is a schematic perspective view of an embodiment of the prismatic battery cell shown in FIG. 1, illustrating horizontally arranged multiple electrode stacks arranged inside the respective cell container and electrically conductive tabs with expandable portions arranged between the electrode stacks, according to the disclosure.

FIG. 7 is a schematic inside view of one embodiment of the pouch battery cell shown in FIG. 1, illustrating multiple electrode stacks arranged inside the respective cell container and electrically conductive tabs with expandable portions arranged between the electrode stacks, according to the disclosure.

FIG. 8 illustrates a flowchart for a method of manufacturing a battery cell having the structure shown in FIGS. 1-7, according to the disclosure.

FIG. 9 illustrates a representative battery monocell constructed by the method shown in FIG. 8.

FIG. 10 illustrates arranging and stacking of anodes, cathodes, and separators for battery monocells shown in FIG. 9, according to the method shown in FIG. 8.

FIG. 11 illustrates electrode material sheets for respective anodes and cathodes.

FIG. 12 illustrates extracting respective anodes and cathodes from corresponding electrode material sheets shown in FIG. 11, according to the method shown in FIG. 8.

FIG. 13 illustrates coating the outer perimeter of each respective cathode with an electrically insulating material, according to the method shown in FIG. 8.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

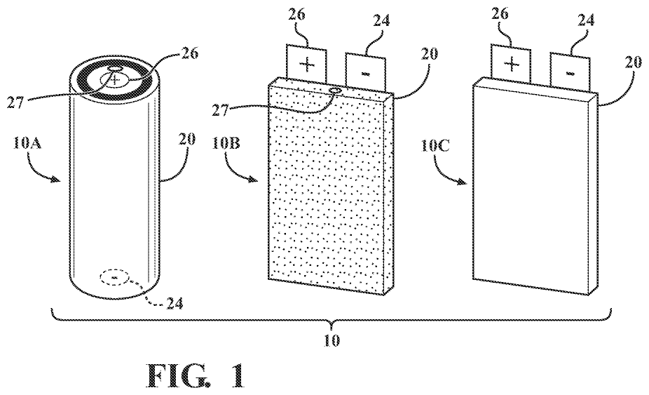

Referring to the figures, three exemplary embodiments of a battery cell 10 are depicted. Specifically, FIG. 1 depicts a cylindrical battery cell 10A, a prismatic battery cell 10B, and a pouch battery cell 10C. Generally, battery cells generate electrical energy through heat-producing electro-chemical reactions. Battery cell 10, such as the cells 10A, 10B, 10C, is configured as a secondary i.e., rechargeable, energy storage cell. The battery cell 10 may, for example, be configured as a lithium-ion (Li-ion) or a lithium metal cell. Battery cells, such as the cells 10A, 10B, 10C shown in FIG. 1 may be employed for operating toys, consumer electronics, and motor vehicles. Multiple cylindrical or prismatic cells may be grouped together in battery modules or packs for enhanced performance in specific applications.

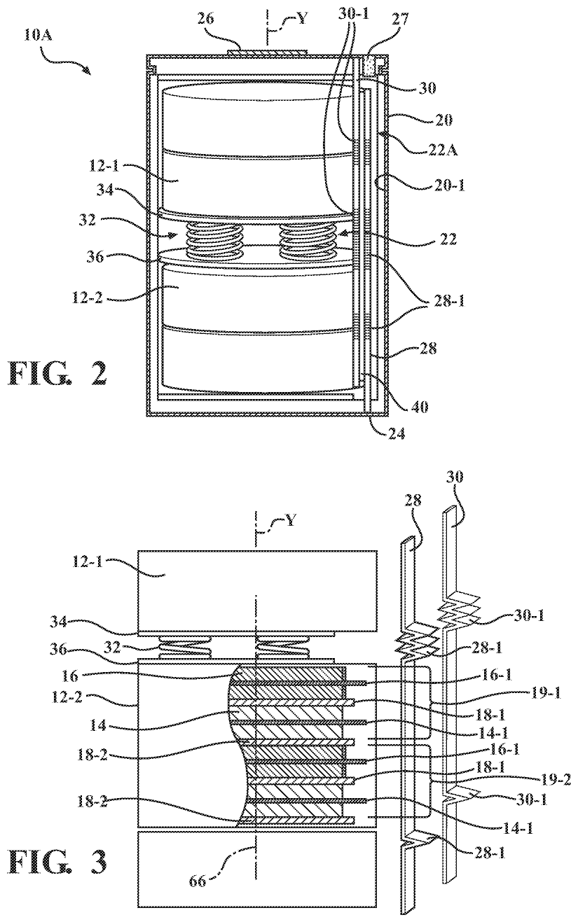

The cylindrical cell 10A generally operates like the rectangular prismatic battery cell 10B and like the pouch battery cell 10C, and the three cell types include functionally analogous internal components. As shown schematically in a cut-away state in FIG. 2, an assembled cylindrical battery cell 10A includes a plurality of electrode stacks, shown as a first stack 12-1 and a second stack 12-1. As shown in FIG. 3, each electrode stack 12-1, 12-2 includes at least one pair of alternating anode 14, e.g., lithium-metal electrode, and cathode 16 e.g., Lithium-Nickel-Manganese-Cobalt-Oxide (NMC) electrode, elements. As shown in FIG. 3, each electrode stack 12-1, 12-2 includes a separator 18 between each anode and cathode. Each separator 18 includes or holds a liquid electrolyte formulated to conduct ions as the battery cell 10 discharges or charges. The separator 18 with electrolyte is disposed in contact with and between anode 14 and cathode 16 elements in each anode and cathode element pair such that each anode and cathode is immersed in or surrounded by the electrolyte. The battery cell 10 may use either liquid electrolyte or solid electrolyte film separating the neighboring anode 14 and cathode 16. Although substantially round electrodes 14, 16 with one flat side are shown, nothing precludes the electrodes from having any desired shape, such as oval, rectangular, trapezoidal, etc.

A single pair of alternating anode 14 and cathode 16 elements together with two separators, a first separator 18-1 arranged between the subject anode and cathode and a second separator 18-2 arranged adjacent to the anode is herein defined as a “monocell”. A monocell is a single self-contained sub-cell which may be used as a building block for constructing the first and second electrode stacks 12-1, 12-2 (and more) to be subsequently assembled into the battery cell 10. Accordingly, the number of moncells in individual electrode stacks and the overall number of stacks may define the desired size, capacity, and output of the resultant battery cell. The electrode stacks 12-1, 12-2 are thereby assembled from one or more monocells. A first such monocell is identified in the drawings via numeral 19-1, while the second monocell is identified via numeral 19-2.

With resumed reference to FIG. 1, each of the embodiments of battery cell 10 also includes a cell case or container 20. Specifically, container 20 of the cylindrical battery cell 10A and the prismatic battery cell 10B may be constructed from a rigid material, typically aluminum or steel. Container 20 of the pouch battery cell 10C, on the other hand, may be constructed from a flexible or pliant material, such as aluminum laminated film made up of aluminum foil sandwiched between layers of polymers. The cell container 20 is generally sealed, e.g., via crimping, adhesive, or welding, to maintain volatile and reactive species within the respective battery cell 10 during charge/discharge cycling, and to prevent moisture, which is detrimental to the cell's performance, from entering the cell. The container 20 is generally arranged along a longitudinal battery axis Y and defines an internal chamber 22 configured to house the first and second electrode stacks 12-1, 12-2.

As shown in FIG. 1, the container 20 includes an externally mounted first or negative battery terminal 24 and an externally mounted second or positive battery terminal 26 for establishing an electrical connection between the subject battery cell and an external load. For example, as may be seen with respect to the cylindrical battery cell 10A, the negative and positive battery terminals 24, 26 may be arranged at opposite sides or ends of container 20 (e.g., one terminal at the top and the other at the bottom of the respective container when the cell is arranged upright in a module). Alternatively, as may be seen with respect to the prismatic and pouch battery cells 10B, 10C, the negative and positive battery terminals 24, 26 may be arranged adjacent to one another on the same side or on opposite sides of container 20. As such, the battery cell 10 may have top, top and bottom, or side-mounted battery terminals 24, 26. The container 20 may also include a vent 27.

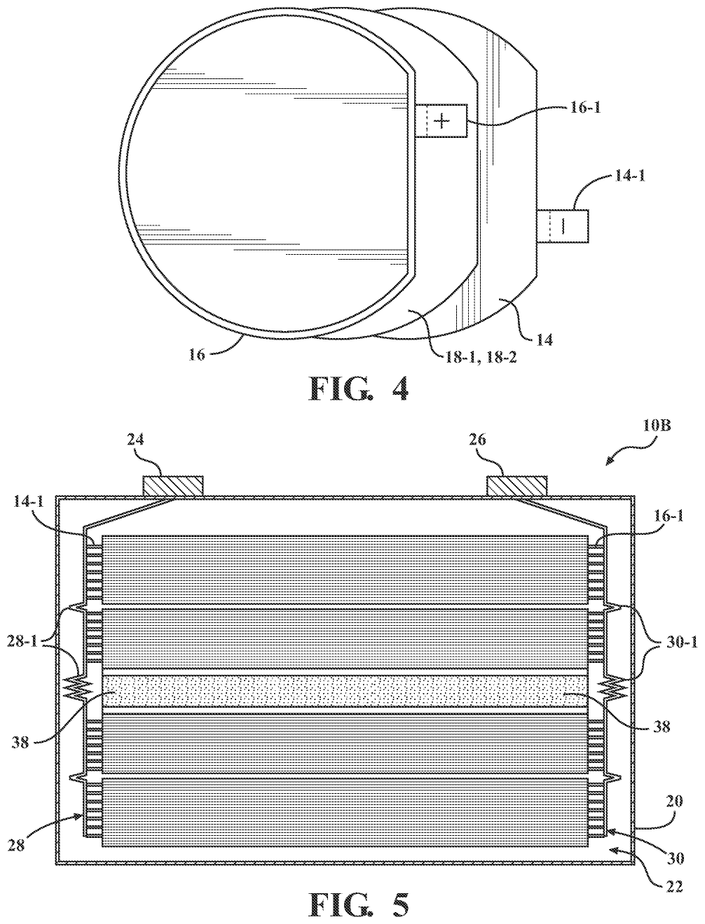

As shown in FIG. 3, battery cell 10 also includes a first electrically conductive weld tab 28 arranged within the internal chamber 22. The first weld tab 28 is mechanically connected (typically welded) to the first battery terminal 24 and is fixedly connected to each anode element 14 in the first and second electrode stacks 12-1, 12-2. The battery cell 10 additionally includes a second electrically conductive weld tab 30 arranged within the internal chamber 22. The second weld tab 30 is mechanically connected (similarly, typically welded) to the second battery terminal 26 and is fixedly connected to each cathode element 16 in the first and second electrode stacks 12-1, 12-2. As shown in FIG. 4, each anode element 14 may have a corresponding negative tab 14-1 and each cathode element 16 may have a corresponding positive tab 16-1. As shown in FIG. 3, the negative tabs 14-1 and positive tabs 16-1 may be folded and welded to corresponding first and second weld tabs 28, 30. Accordingly, each anode 14 is in continuous electrical contact with the negative terminal 24, while each cathode 16 is in continuous electrical contact with a positive terminal 26.

With continued reference to FIG. 3, the first weld tab 28 includes a first expandable portion 28-1 arranged between the first and second electrode stacks 12-1, 12-2. Similarly, the second weld tab 30 includes a second expandable portion 30-1 arranged between the first and second electrode stacks 12-1, 12-2. Each of the first and second expandable portions 28-1, 30-1 is configured to absorb alternating expansion and contraction of the first and second electrode stacks 12-1, 12-2, when the battery cell 10 is respectively charging and discharging. The expansion and contraction of the first and second electrode stacks 12-1, 12-2 occurs primarily due to volume variation of the constituent anode elements 14. As shown in FIGS. 3, 5, 6A, 6B, and 7, each of the expandable portions 28-1, 30-1 may be configured as an accordion or a corrugated section of the respective weld tab 28, 30 configured to selectively extend and compress to accommodate expansion and contraction of the first and second electrode stacks 12-1, 12-2.

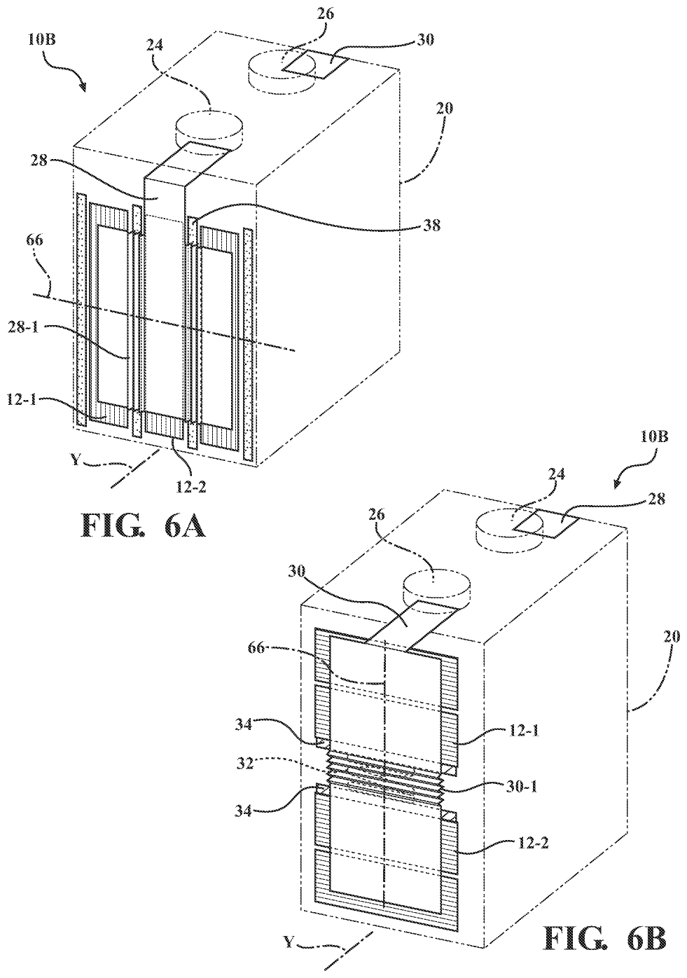

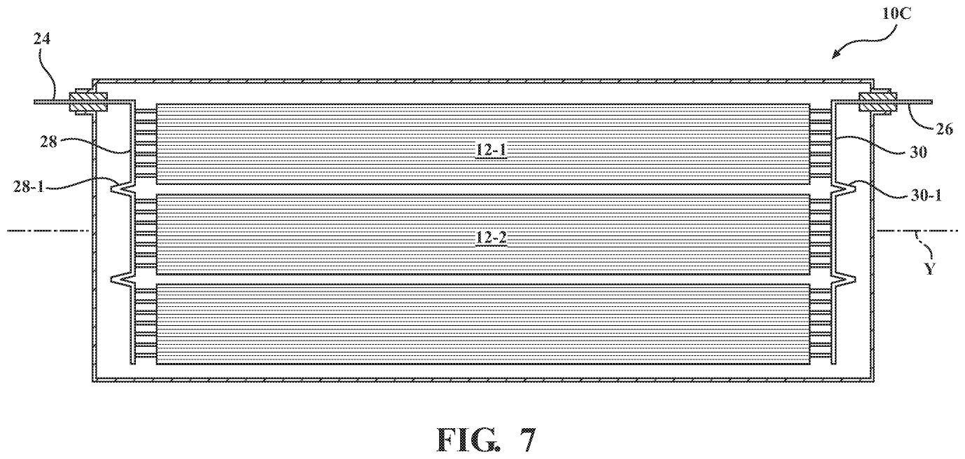

Each of the first and second weld tabs 28, 30 and each of the first and second expandable portions 28-1, 30-1 may be arranged parallel to the longitudinal battery axis Y, such as in the cylindrical and prismatic battery cells 10A, 10B with electrode stacks 12-1, 12-2 positioned along the axis Y (shown in FIG. 2). Alternatively, each of the first and second expandable portions 28-1, 30-1 may be arranged perpendicular to the longitudinal battery axis Y, such as in the prismatic and pouch battery cells 10B, 10C with electrode stacks 12-1, 12-2 positioned in a plane orthogonal to the axis Y (shown in FIGS. 6A and 6B). A specific embodiment of the pouch cell 10C is shown in FIG. 7, illustrating the arrangement of the electrically conductive tabs 28, 30 between the electrode stacks, relative to side-mounted negative and positive terminals 24, 26 and to the longitudinal battery axis Y.

As shown in FIGS. 2 and 6B, one or more spring elements 32 may be arranged between the first and second electrode stacks 12-1, 12-2. The spring element(s) 32 are intended to accommodate expansion of the first and second electrode stacks 12-1, 12-2 inside the battery cell container 20. Additionally, the battery cell 10 may include a first support plate 34 disposed adjacent to the first electrode stack 12-1 and a second support plate 36 disposed adjacent to the second electrode stack 12-2. The spring element(s) 32 may be arranged between the first and second support plates 34, 36. Alternatively or additionally, the battery cell 10 may include foam elements 38 arranged between electrode stacks 12-1, 12-2 (shown in FIGS. 5 and 6A). Larger first and second expandable portions 28-1, 30-1 may be used to accommodate expansion and contraction of the spring or foam element(s) 32, 38. Specifically, as shown in FIGS. 3 and 5, the first and second expandable portions 28-1, 30-1 may be configured to provide greater elongation near the spring or foam element(s) 32, 38, as compared to areas between stacks 12-1, 12-2 without such intervening elements.

With resumed reference to FIG. 2, the battery cell container 20 has an interior surface 20-1 facing the internal chamber 22. The first conductive weld tab 28 and the second conductive weld tab 30 may be disposed in a region 22A of the internal chamber 22 between the first and second electrode stacks 12-1, 12-2 and the interior surface 20-1. The battery cell 10 may additionally include a separation bracket 40. As shown in FIG. 2, the separation bracket 40 is disposed in the region 22A and configured to prevent cell short circuit by maintaining separation and preventing accidental contact between the first weld tab 28 and the second weld tab 30. The separation bracket 40 may be constructed from an electrically insulating material such as a heat and chemically resistant polymer or a coated metal.

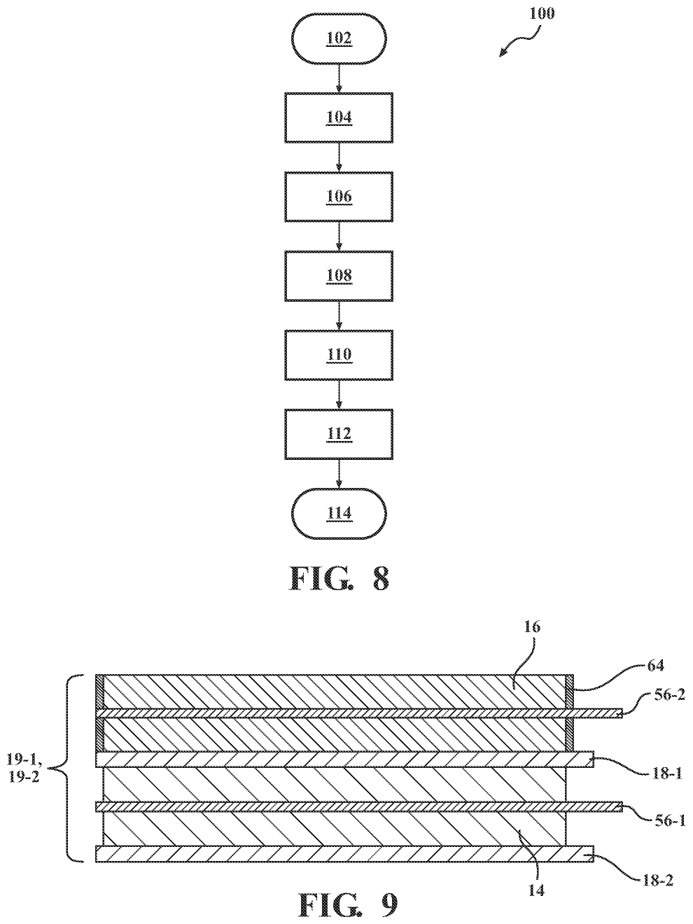

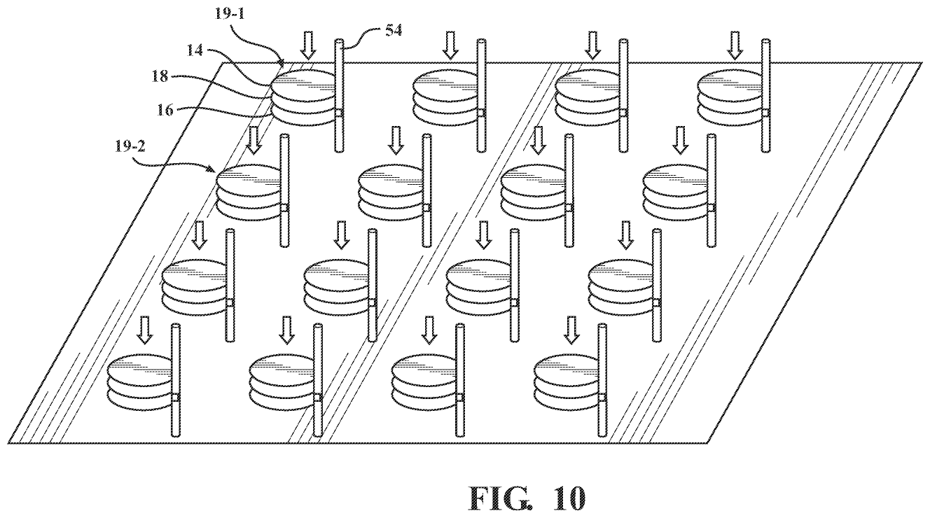

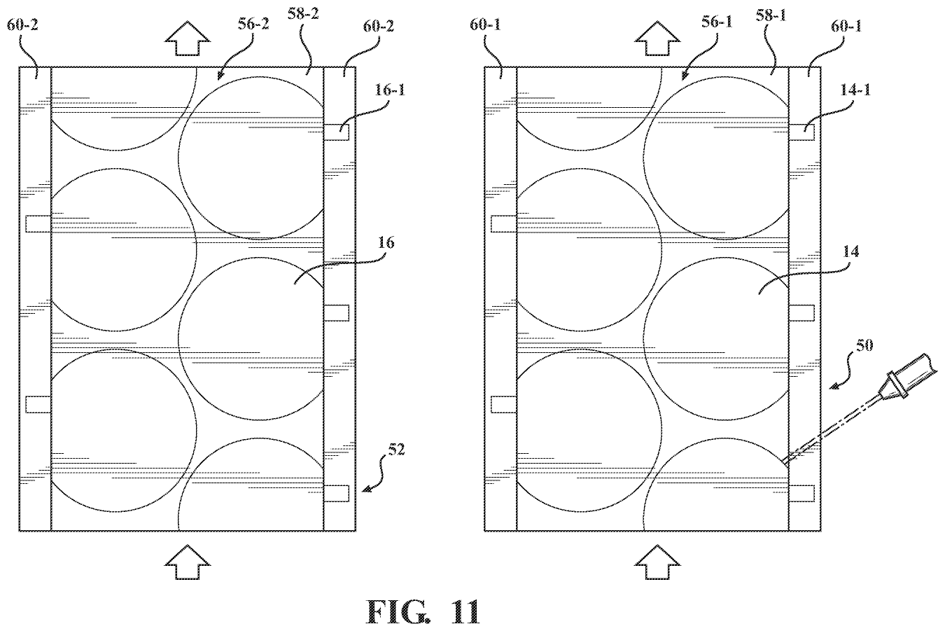

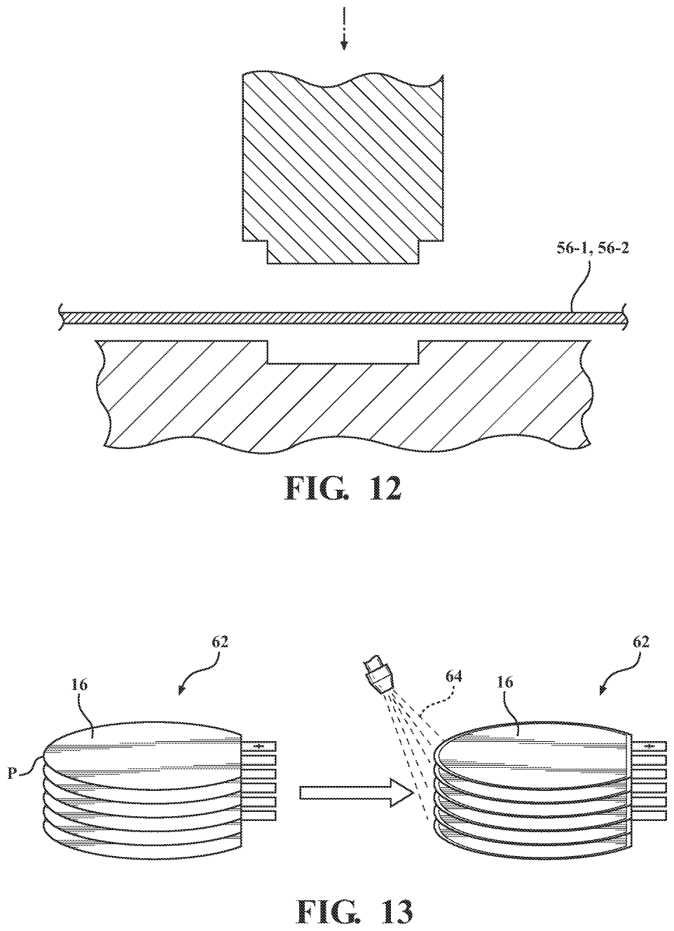

A method 100 of manufacturing the battery cell 10 is depicted in FIG. 8 and disclosed in detail below. Method 100 may be used as a scalable batch process of constructing a large number of battery cells with multiple stacked electrodes 14, 16, as described above with respect to FIGS. 1-7. Accordingly, the method may be used to manufacture battery cells depicted in each of the FIGS. 2, 3, 5, 6A, 6B, and 7. Method 100 commences in frame 102 with providing or constructing the battery cell container 20. Following frame 102, the method advances to frame 104. In frame 104, the method includes generating the first battery monocell 19-1 having a respective anode 14, cathode 16, first separator 18-1 arranged therebetween, and the second separator 18-2 arranged adjacent to the corresponding anode 14 (as shown in FIG. 9). In frame 104, the method may also include initially extracting the respective anodes 14 and cathodes 16 from corresponding electrode material sheets, an anode sheet 50 and a cathode sheet 52, as shown in FIG. 12. Extracting the respective anodes and cathodes 14, 16 may specifically include either laser (shown in FIG. 11) or die cutting (shown in FIG. 12) the respective anodes and cathodes from corresponding electrode material sheets 50, 52. Generating the first battery monocell 19-1 may be accomplished with the aid of an alignment guide 54, as shown in FIG. 10.

The electrode material sheets 50, 52 may be prepared or constructed from respective anode and cathode material, such as via slurry coating the respective anode and cathode material onto a corresponding base material foil, anode (copper) foil 56-1 and cathode (aluminum) foil 56-2 (shown in FIG. 11). According to the method, thus constructed electrode material sheets 50, 52 may include respective coated and dried material strip 58-1 for the anodes 14 and a coated and dried material strip 58-2 for the cathodes 16. Additionally, in frame 104, the method may include generating at least one respective exposed material section 60-1, 60-2 on the corresponding base material foil 56-1, 56-2 (of the electrode material sheets 50, 52) for the corresponding conductive negative and positive tabs 14-1, 16-1. From frame 104, the method proceeds to frame 106.

In frame 106, the method includes generating the second battery monocell 19-2 having a respective anode 14, cathode 16, first separator 18-1 arranged therebetween, and a second separator 18-2 arranged adjacent to the corresponding anode 14 (shown in FIG. 10). Similar to generating the first battery monocell 19-1, generating the second battery monocell 19-2 may be accomplished with the aid of the alignment guide 54. As may be seen in FIG. 12, each cathode 16 of the respective first and second battery monocells 19-1, 19-2 is defined by a corresponding outer perimeter P. Generating the first and second battery monocells 19-1, 19-2 in respective frames 104 and 106 may include tightly arranging or stacking each of the cathodes 16 in a column 62 and coating the outer perimeter P of each respective cathode with an electrically insulating material 64 (as shown in FIG. 13). For example, the outer perimeter P may be spray on or solution coated with a ceramic material having a polymer binder. The positive tabs 14-1 of the subject cathodes 16 may be masked to avoid coating thereof. After frame 106, the method advances to frame 108.

In frame 108, the method includes arranging the first and second battery monocells 19-1, 19-2 adjacent to one another (for example as shown in FIG. 10), such as one above the other in a column or side-by-side for cylindrical, prismatic, and pouch cells 10A, 10B, 10C. Additionally, in frame 108, the method includes stacking the first battery monocell 19-1 and the second battery monocell 19-2 such that the second separator 18-2 of the first battery monocell is adjacent to the cathode 16 of the second battery monocell (as shown in FIG. 3). In other words, the second separator 18-2 provides a functional interface between the first monocell 19-1 and the second monocell 19-2 in the resultant battery cell 10. Although the method specifically describes stacking the first and second battery monocells 19-1, 19-2, in frame 108 the method may include stacking as many monocells as desired to generate a specific battery cell 10.

In frame 108, the method may also include arranging one or more spring elements 32 between the stacked first and second battery monocells 19-1, 19-2 (shown for example in FIG. 2). Furthermore, in frame 108, the method may include arranging the first support element 34 in contact with the cathode 16 of the first battery monocell 19-1 and the second support element 36 in contact with the second separator 18-2 of the first battery monocell 19-1. As a result, the spring element(s) would be sandwiched by the first and second support elements 34, 36 and spread the load from the spring element(s) across the surface of the adjacent monocells. Alternatively, or in addition to the springs 32, in frame 108, the method may include arranging the foam element 38 between the first and second battery monocells 19-1, 19-2. Following frame 108, the method advances to frame 110.

In frame 110, the method includes arranging the stacked first and second battery monocells 19-1, 19-2 in the battery cell container 20 along a stack axis 66 that is either along or perpendicular to the longitudinal battery axis Y (shown in FIG. 3). From frame 110, after arranging the stacked monocells 19-1, 19-2 in the container 20, the method may proceed to frame 112. In frame 112, the method includes mechanically connecting the negative and positive tabs 14-1, 16-1 of each battery monocell 19-1, 19-2 to the battery negative and positive battery terminals 24, 26 via the weld tabs 28, 30 arranged along the stack axis 66. The negative and positive tabs 14-1, 16-1 may be grouped and folded to fit inside the battery cell container 20 prior to being connected to the respective weld tabs 28, 30. In frame 112, the method may also include arranging the separation bracket 40 in the region 22A between the first weld tab 28 and the second weld tab 30. As described above with respect to FIGS. 2-7, the weld tabs 28, 30 include expandable portions 28-1, 30-1 for absorbing alternating expansion and contraction of the first and second battery monocells 19-1, 19-2 when the battery cell 10 is respectively charging and discharging. After frame 112, the method may conclude in frame 114 with packaging the manufactured battery cell(s) for storage or assembly into a battery module or pack.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of manufacturing a battery cell comprising:
providing a battery cell container;
generating a first battery monocell having a respective anode, cathode, first separator arranged therebetween, and a second separator arranged adjacent to the corresponding anode;
generating a second battery monocell having a respective anode, cathode, first separator arranged therebetween, and a second separator arranged adjacent to the corresponding anode;
stacking the first battery monocell and the second battery monocell such that the second separator of the first battery monocell is adjacent to the cathode of the second battery monocell; and
arranging the stacked first and second battery monocells in the battery cell container.

2. The method of manufacturing a battery cell according to claim 1, wherein stacking the first battery monocell and the second battery monocell includes arranging at least one spring element between the first and second battery monocells.

3. The method of manufacturing a battery cell according to claim 2, wherein stacking the first battery monocell and the second battery monocell additionally includes arranging a first support element in contact with the cathode of the first battery monocell and a second support element in contact with the second separator of the first battery monocell such that the at least one spring element is sandwiched by the first and second support elements.

4. The method of manufacturing a battery cell according to claim 1, wherein generating the first and second battery monocells includes extracting the respective anodes and cathodes from corresponding electrode material sheets.

5. The method of manufacturing a battery cell according to claim 4, wherein extracting the respective anodes and cathodes includes one of die and laser cutting the respective anodes and cathodes from corresponding electrode material sheets.

6. The method of claim 4, wherein the electrode material sheets are constructed from respective anode and cathode material, and wherein generating the first and second battery monocells includes coating the respective electrode material onto a corresponding base material foil.

7. The method of manufacturing a battery cell according to claim 6, wherein each of the respective anodes and cathodes includes at least one conductive tab, and wherein coating the respective electrode material onto the corresponding base material foil includes generating a respective coated material strip for each of the anodes and the cathodes and at least one exposed material section on each respective base material foil for the corresponding conductive tabs.

8. The method of manufacturing a battery cell according to claim 7, wherein each cathode of the respective first and second battery monocells is defined by a corresponding outer perimeter, and wherein generating the first and second battery monocells includes arranging each cathode in a column and coating the outer perimeter of each respective cathode with an electrically insulating material.

9. The method of manufacturing a battery cell according to claim 8, wherein generating the first and second battery monocells includes masking each conductive tab prior to coating the outer perimeter of each respective cathode.

10. The method of manufacturing a battery cell according to claim 1, wherein the battery cell is one of a cylindrical, a prismatic, and a pouch cell.

11. A method of manufacturing a lithium-ion cylindrical battery cell comprising:
providing a battery cell container;
generating a first battery monocell having a respective lithium-metal anode, cathode, first separator arranged therebetween, and a second separator arranged adjacent to the corresponding anode:
generating a second battery monocell having a respective anode, cathode, first separator arranged therebetween, and a second separator arranged adjacent to the corresponding anode;
wherein generating the first and second battery monocells includes extracting the respective anodes and cathodes from corresponding electrode material sheets via one of die and laser cutting the respective anodes and cathodes from corresponding electrode material sheets;
stacking the first battery monocell and the second battery monocell such that the second separator of the first battery monocell is adjacent to the cathode of the second battery monocell; and
arranging the stacked first and second battery monocells in the battery cell container.

12. The method of manufacturing a lithium-ion cylindrical battery cell according to claim 11, wherein stacking the first battery monocell and the second battery monocell includes arranging at least one spring element between the first and second battery monocells.

13. The method of manufacturing a lithium-ion cylindrical battery cell according to claim 12, wherein stacking the first battery monocell and the second battery monocell additionally includes arranging a first support element in contact with the cathode of the first battery monocell and a second support element in contact with the second separator of the first battery monocell such that the at least one spring element is sandwiched by the first and second support elements.

14. The method of manufacturing a lithium-ion cylindrical battery cell according to claim 11, wherein the electrode material sheets are constructed from respective anode and cathode material, and wherein generating the first and second battery monocells includes coating the respective electrode material onto a corresponding base material foil.

15. The method of manufacturing a lithium-ion cylindrical battery cell according to claim 14, wherein each of the respective anodes and cathodes includes at least one conductive tab, and wherein coating the respective electrode material onto the corresponding base material foil includes generating a respective coated material strip for each of the anodes and the cathodes and at least one exposed material section on each respective base material foil for the corresponding conductive tabs.

16. The method of manufacturing a lithium-ion cylindrical battery cell according to claim 15, wherein each cathode of the respective first and second battery monocells is defined by a corresponding outer perimeter, and wherein generating the first and second battery monocells includes arranging each cathode in a column and coating the outer perimeter of each respective cathode with an electrically insulating material.

17. The method of manufacturing a lithium-ion cylindrical battery cell according to claim 16, wherein generating the first and second battery monocells includes masking each conductive tab prior to coating the outer perimeter of each respective cathode.

18. A method of manufacturing a lithium-ion battery cell comprising:
providing a battery cell container;
generating a first battery monocell having a respective lithium-metal anode, cathode, first separator arranged therebetween, and a second separator arranged adjacent to the corresponding anode;
generating a second battery monocell having a respective anode, cathode, first separator arranged therebetween, and a second separator arranged adjacent to the corresponding anode;
stacking the first battery monocell and the second battery monocell such that the second separator of the first battery monocell is adjacent to the cathode of the second battery monocell, including:
arranging at least one spring element between the first and second battery monocells; and
arranging a first support element in contact with the cathode of the first battery monocell and a second support element in contact with the second separator of the first battery monocell such that the at least one spring element is sandwiched by the first and second support elements; and
arranging the stacked first and second battery monocells in the battery cell container.

19. The method of manufacturing a battery cell according to claim 18, wherein generating the first and second battery monocells includes extracting the respective anodes and cathodes via one of die and laser cutting the respective anodes and cathodes from corresponding electrode material sheets.

20. The method of claim 19, wherein the electrode material sheets are constructed from respective anode and cathode material, and wherein generating the first and second battery monocells includes coating the respective electrode material onto a corresponding base material foil.
